(19) United States
(12) Patent Application Publication
(10) Pub. No.: US 2026/0205969 A1
(43) Pub. Date: Jul. 16, 2026

(54) INDEPENDENT SYNCHRONIZATION REFERENCE DETERMINATION FOR SIDELINK SYNCHRONIZATION

(71) Applicant: QUALCOMM Incorporated, San Diego, CA (US)

(72) Inventors: Shijun WU, San Diego, CA (US); Kapil GULATI, Belle Mead, NJ (US); Hong CHENG, Basking Ridge, NJ (US)

(21) Appl. No.: 19/017,213

(22) Filed: Jan. 10, 2025

(51) Int. Cl. H04W 56/00; H04W 24/02; H04W 24/08; H04W 92/18

(52) U.S. Cl. CPC H04W 56/0015; H04W 24/02; H04W 24/08; H04W 92/18

(57) ABSTRACT

Methods, systems, and devices for wireless communications at a user equipment (UE) are described. The UE may receive control signaling that may indicate a range of a power offset associated with a synchronization signal. The UE may monitor a wireless channel for the synchronization signal. The UE may transmit a sidelink synchronization signal block (SSB) as an independent synchronization reference based on the monitoring and the range of the power offset associated with the synchronization signal.

### FIELD OF TECHNOLOGY

The following relates to wireless communications at a user equipment (UE), including independent synchronization reference determination for sidelink synchronization.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving control signaling that indicates a range of a power offset associated with a synchronization signal, monitoring a wireless channel for the synchronization signal, and transmitting a sidelink synchronization signal block (SSB) as an independent synchronization reference based on the monitoring and the range of the power offset associated with the synchronization signal.

A UE for wireless communications is described. The UE may include one or more memories storing processor executable code, and one or more processors coupled with the one or more memories. The one or more processors may individually or collectively be operable to execute the code to cause the UE to receive control signaling that indicates a range of a power offset associated with a synchronization signal, monitor a wireless channel for the synchronization signal, and transmit a sidelink SSB as an independent synchronization reference based on the monitoring and the range of the power offset associated with the synchronization signal.

Another UE for wireless communications is described. The UE may include means for receiving control signaling that indicates a range of a power offset associated with a synchronization signal, means for monitoring a wireless channel for the synchronization signal, and means for transmitting a sidelink SSB as an independent synchronization reference based on the monitoring and the range of the power offset associated with the synchronization signal.

A non-transitory computer-readable medium storing code for wireless communications is described. The code may include instructions executable by one or more processors to receive control signaling that indicates a range of a power offset associated with a synchronization signal, monitor a wireless channel for the synchronization signal, and transmit a sidelink SSB as an independent synchronization reference based on the monitoring and the range of the power offset associated with the synchronization signal.

Some examples of the method, UEs, and non-transitory computer-readable medium described herein may further include operations, features, means, or instructions for selecting a value of the power offset in accordance with the range of the power offset and in accordance with one or more measured environmental parameters, where the one or more measured environmental parameters may be associated with monitoring the wireless channel for the synchronization signal.

In some examples of the method, UEs, and non-transitory computer-readable medium described herein, the one or more measured environmental parameters include one or more of a received signal strength, a signal to interference noise ratio (SINR), a sidelink service set identifier (SLSSID), a power delay profile, a channel impulse response, a difference in time between a set of multiple synchronization signals, a difference in frequency between the set of multiple synchronization signals, or any combination thereof and the set of multiple synchronization signals includes the synchronization signal.

Some examples of the method, UEs, and non-transitory computer-readable medium described herein may further include operations, features, means, or instructions for transmitting an indication of the one or more measured environmental parameters.

In some examples of the method, UEs, and non-transitory computer-readable medium described herein, the one or more measured environmental parameters and the range of the power offset include input parameters for a machine learning (ML) model.

Some examples of the method, UEs, and non-transitory computer-readable medium described herein may further include operations, features, means, or instructions for receiving the synchronization signal based on monitoring the wireless channel and comparing a power associated with the synchronization signal to a threshold power, the threshold power associated with the power offset associated with the range of the power offset, where transmission of the sidelink SSB may be based on the comparing.

In some examples of the method, UEs, and non-transitory computer-readable medium described herein, transmitting the sidelink SSB may include operations, features, means, or instructions for transmitting the sidelink SSB based on an internal timing associated with an internal clock at the UE.

In some examples of the method, UEs, and non-transitory computer-readable medium described herein, the range of the power offset includes a maximum value and a minimum value, one or more candidate values for the power offset, or any combination thereof.

In some examples of the method, UEs, and non-transitory computer-readable medium described herein, transmitting the sidelink SSB may include operations, features, means, or instructions for transmitting the sidelink SSB based on an output of a ML model.

In some examples of the method, UEs, and non-transitory computer-readable medium described herein, the output of the ML model includes a value of the power offset in accordance with the range of the power offset and transmission of the sidelink SSB may be based on the value of the power offset.

In some examples of the method, UEs, and non-transitory computer-readable medium described herein, the output of the ML model includes an indication to transmit the sidelink SSB as an independent synchronization reference and transmission of the sidelink SSB may be based on the indication.

Some examples of the method, UEs, and non-transitory computer-readable medium described herein may further include operations, features, means, or instructions for receiving second control signaling that indicates a configuration for the ML model.

Some examples of the method, UEs, and non-transitory computer-readable medium described herein may further include operations, features, means, or instructions for receiving second control signaling that indicates one or more parameters for training the ML model and training the ML model in accordance with the one or more parameters and in accordance with measured values associated with the one or more parameters.

Some examples of the method, UEs, and non-transitory computer-readable medium described herein may further include operations, features, means, or instructions for receiving second control signaling that indicates one or more environmental parameters associated with a measurement procedure at the UE, where an input for the ML model may be based on the one or more environmental parameters.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show an example of wireless communications systems that support independent synchronization reference determination for sidelink synchronization in accordance with one or more aspects of the present disclosure.

FIG. 3 shows an example of a chain diagram that supports independent synchronization reference determination for sidelink synchronization in accordance with one or more aspects of the present disclosure.

FIG. 4 shows an example of a block diagram that supports independent synchronization reference determination for sidelink synchronization in accordance with one or more aspects of the present disclosure.

FIG. 5 shows an example of a process flow that supports independent synchronization reference determination for sidelink synchronization in accordance with one or more aspects of the present disclosure.

FIGS. 6 and 7 show block diagrams of devices that support independent synchronization reference determination for sidelink synchronization in accordance with one or more aspects of the present disclosure.

FIG. 8 shows a block diagram of a communications manager that supports independent synchronization reference determination for sidelink synchronization in accordance with one or more aspects of the present disclosure.

FIG. 9 shows a diagram of a system including a device that supports independent synchronization reference determination for sidelink synchronization in accordance with one or more aspects of the present disclosure.

FIGS. 10 and 11 show flowcharts illustrating methods that support independent synchronization reference determination for sidelink synchronization in accordance with one or more aspects of the present disclosure.

### DETAILED DESCRIPTION

In some wireless communications systems, user equipments (UEs) may be synchronized in order to perform communication. For example, in a vehicle-to-everything (V2X) system, multiple UEs may be synchronized and may perform sidelink communications. In some aspects, a UE may synchronize to a global navigation satellite system (GNSS) using GNSS signals. All UEs synchronized to the GNSS may also be synchronized with each other. However, in some cases, a UE may not be able to synchronize to the GNSS. For example, the GNSS signals may be blocked or the UE may not have the capability to receive GNSS signals. UEs synchronized with the GNSS may transmit sidelink synchronization signal blocks (SSBs). A UE (e.g., a UE that may not receive the GNSS signals) may receive the sidelink SSBs. The UE that may not receive GNSS signals may instead synchronize with the sidelink SSB transmitted from another UE. Multiple UEs may synchronize in such a way, depending on environmental parameters, which may lead to a chain of UEs. However, the “farther away” in the chain a UE is, the more likely there may be error introduced and propagated through the synchronization.

In some cases, a UE may act as an independent source or reference of sidelink SSBs for other UEs without synchronizing with GNSS. For example, a UE may be unable to receive GNSS and may not detect any sidelink SSBs or may not detect reliable sidelink SSBs (e.g., a threshold quantity of SSBs received from the same source, or SSBs satisfying a threshold offset above a minimum reference signal received power (RSRP)). In such cases, the UE may begin to transmit sidelink SSBs that other UEs may use to synchronize with it.

A UE may become an independent synchronization reference (e.g., independent synchronization source) based on a configured offset with respect to a reference or threshold RSRP value. For example, if an RSRP of a detected SL SSB is less than the preconfigured offset from a threshold (e.g., minimum) value of an RSRP, the UE may determine to become an independent synchronization reference. The offset may allow different UEs to be configured with different likelihoods of becoming independent synchronization references (e.g., a UE configured with a relatively higher offset from the threshold value of the RSRP may be more likely to become an independent synchronization reference than a UE configured with a relatively lower offset from the threshold value of the RSRP). However, as environmental conditions change and based on capabilities at a UE, such as machine learning (ML) capabilities, a UE may be more capable of autonomously determining an appropriate value for the power offset or of determining whether to become an independent synchronization reference. That is, the preconfigured, or semi-static, power offset may not be dynamic enough to adapt to a rapidly changing UE environment, and a sidelink environment may be better served by one or more UEs that have the capability to perform measurements and determine offset values situationally.

The techniques described herein may support a UE determining a value for a power offset from a threshold (e.g., minimum) RSRP dynamically, such that the UE may autonomously and independently determine whether to become an independent sidelink synchronization source based on a capability of the UE and measured environmental factors. For example, a network entity may configure a UE with a range of possible values for the power offset. The range may be a set of possible values or a range indicated by a maximum and minimum value. In some aspects, the UE may use an artificial intelligence (AI) or ML model (AI/ML model) to select an applicable offset associated with whether to become an independent synchronization reference. For example, the UE may measure some environmental factors, such as an RSRP of a received sidelink SSB, a signal-to-interference-plus-noise ratio (SINR) of a received sidelink SSB, a difference in time or frequency between detections of a sidelink SSB from a same source (e.g., based on a sidelink service set identifier (SLSSID)), or the like. The UE may input the range of values for the power offset and the measured environmental factors into the AI/ML model. In some examples, the AI/ML model may indicate a value for the power offset, and the UE may select a value for the power offset within the range of values in accordance with the indicated value. In other examples, the AI/ML model may indicate directly that the UE is to act as an independent synchronization reference. The UE may transmit a sidelink SSB as an independent synchronization reference in accordance with the output of the AI/ML model.

Particular aspects of the subject matter described in this disclosure can be implemented to realize one or more of the following potential advantages. The UE may be able to implement an improved utilization of a processing capability or an AI/ML capability by implementing a procedure to more dynamically determine whether to become an independent synchronization reference. By leveraging the capability of the UE, the UE may perform sidelink communication with an improved communication reliability due to improved timing and coordination between devices, including the UE and other sidelink devices. The synchronization process for UEs may thus be more dynamic, configurable, and responsive to environmental changes.

Aspects of the disclosure are initially described in the context of wireless communications systems, chain diagrams, and block diagrams. Aspects of the disclosure are further illustrated by and described with reference to apparatus diagrams, system diagrams, and flowcharts that relate to independent synchronization reference determination for sidelink synchronization.

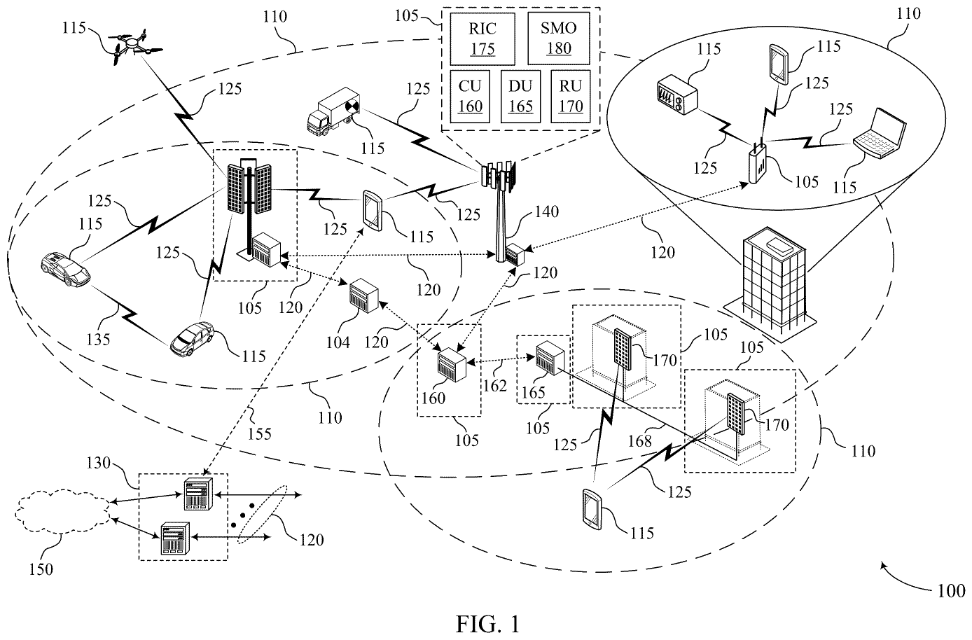

FIG. 1 shows an example of a wireless communications system 100 that supports independent synchronization reference determination for sidelink synchronization in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3(L 3 ), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1(L 1 ) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support independent synchronization reference determination for sidelink synchronization as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(ΔfₘₐₓΔN_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023). Each frame may include multiple consecutively-numbered subframes or

slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation. A subframe, a slot, a mini-slot, or a symbol may be the smallest scheduling

unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may support synchronous or asynchronous operation. For synchronous operation, network entities 105 (e.g., base stations 140) may have similar frame timings, and transmissions from different network entities (e.g., different ones of the network entities 105) may be approximately aligned in time. For asynchronous operation, network entities 105 may have different frame timings, and transmissions from different network entities (e.g., different ones of network entities 105) may, in some examples, not be aligned in time. The techniques described herein may be used for either synchronous or asynchronous operations.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems 100, UEs 115 may be synchronized in order to perform communication. For example, in a V2X system, multiple UEs 115 may be synchronized and may perform sidelink communications. In some aspects, a UE 115 may synchronize to a GNSS using GNSS signals. All UEs 115 synchronized to the GNSS may also be synchronized with each other. However, in some cases, a UE 115 may not be able to synchronize to the GNSS. For example, the GNSS signals may be blocked or the UE 115 may not have the capability to receive GNSS signals. UEs 115 synchronized with the GNSS may transmit sidelink SSBs, which a UE 115 that may not receive GNSS signals may receive. The UE 115 that may not receive GNSS signals may instead synchronize with the sidelink SSB transmitted from another UE 115. Multiple UEs 115 may synchronize in such a way, depending on environmental parameters, which may lead to a chain of UEs 115. However, the “farther away” in the chain a UE 115 is, the more likely there may be error introduced and propagated through the synchronization.

In some cases, a UE 115 may act as an independent source of sidelink SSBs for other UEs 115 without synchronizing with GNSS. For example, a UE 115 may be unable to receive GNSS and may not detect any sidelink SSBs or may not detect reliable sidelink SSBs (e.g., a threshold quantity of SSBs received from the same source, or SSBs satisfying a threshold offset above a minimum RSRP). In such cases, the UE 115 may begin to transmit sidelink SSBs that other UEs may use to synchronize with it.

A UE 115 may become an independent synchronization reference based on a configured offset with respect to a reference or threshold RSRP value. For example, if an RSRP of a detected SL SSB is less than the preconfigured offset from a threshold (e.g., minimum) value of an RSRP, the UE 115 may determine to become an independent synchronization reference. The offset may allow different UEs 115 to be configured with different likelihoods of becoming independent synchronization references (e.g., a UE 115 configured with a relatively higher offset from the threshold value of the RSRP may be more likely to become an independent synchronization reference than a UE 115 with configured with a relatively lower offset from the threshold value of the RSRP). However, as environmental conditions change and based on capabilities at a UE, such as ML capabilities, a UE 115 may be more capable of autonomously determining an appropriate value for the power offset or of determining whether to become an independent synchronization reference. That is, the preconfigured, or semi-static, power offset may not be dynamic enough to adapt to a rapidly changing UE 115 environment, and a sidelink environment may be better served by one or more UEs 115 that have the capability to perform measurements and determine offset values situationally.

The techniques described herein may support a UE 115 determining a value for a power offset from a threshold (e.g., minimum) RSRP dynamically, such that the UE 115 may autonomously and independently determine whether to become an independent sidelink synchronization source based on a capability of the UE 115 and measured environmental factors. For example, a network entity 105 may configure a UE 115 with a range of possible values for the power offset. The range may be a set of possible values or a range indicated by a maximum and minimum value. In some aspects, the UE may use an AI/ML model to select an applicable offset associated with whether to become an independent synchronization reference. For example, the UE 115 may measure some environmental factors, such as an RSRP of a received sidelink SSB, a SINR of a received sidelink SSB, a difference in time or frequency between detections of a sidelink SSB from a same source (e.g., based on a SLSSID), or the like. The UE 115 may input the range of values for the power offset and the measured environmental factors into the AI/ML model. In some examples, the AI/ML model may indicate a value for the power offset, and the UE 115 may select a value for the power offset within the range of values in accordance with the indicated value. In other examples, the AI/ML model may indicate directly that the UE 115 is to act as an independent synchronization reference. The UE 115 may transmit a sidelink SSB as an independent synchronization reference in accordance with the output of the AI/ML model.

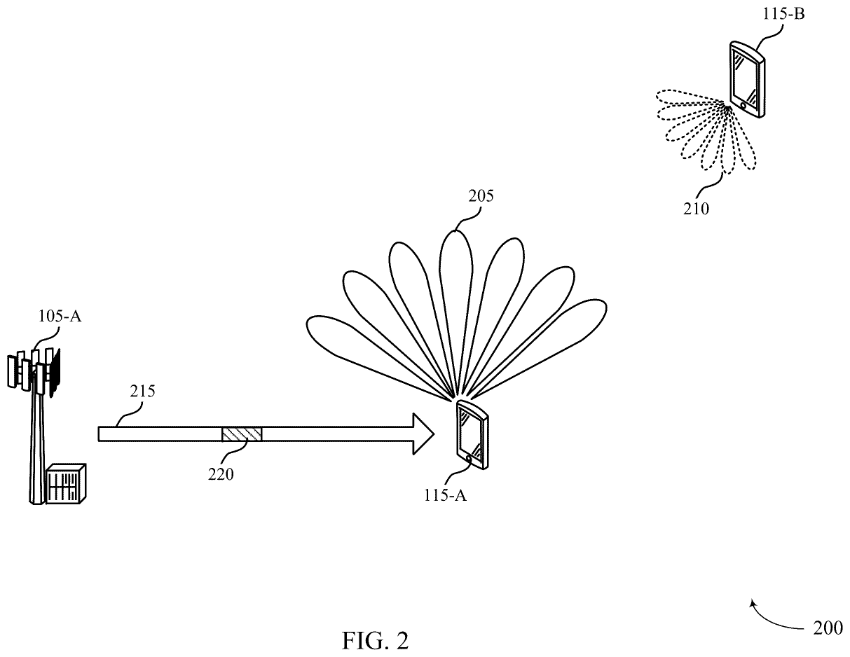

FIG. 2 shows an example of a wireless communications system 200 that supports independent synchronization reference determination for sidelink synchronization in accordance with one or more aspects of the present disclosure. The wireless communications system 200 may implement, or be implemented by, aspects of the wireless communications system 100. For example, the wireless communications system 200 may include one or more network entities 105 and UEs 115, including at least the network entity 105-a and the UEs 115-a and 115-b, which may be examples of corresponding devices as described herein, including with reference to FIG. 1. The techniques described herein in the context of the wireless communications system 200 may support a UE 115-a to determine to become an independent synchronization reference based on autonomously selecting a value of a power offset in accordance with dynamic environmental conditions.

In some wireless communications systems 200, UEs 115 may operate in a synchronized manner. For example, sidelink-based V2X communication systems, as well as other orthogonal frequency division multiplexing (OFDM) systems, may rely on synchronized operations between devices, such as UEs 115, network entities 105, and other devices. In some cases, sidelink-based V2X communication systems may be deployed in a dedicated spectrum (e.g., intelligent transportation systems (ITS) spectrum), where there may be no cellular coverage. That is, a UE 115-a may communicate with other UEs 115, such as the UE 115-b, or wireless devices via a wireless spectrum out of range of the network entity 105-a.

A UE 115 or wireless device performing sidelink communication, such as a V2X UE 115-a installed on a vehicle, may include a paired GNSS receiver. The GNSS receiver may enable the UE 115-a to synchronize with the GNSS. If all UEs 115 may be synchronized with the GNSS, they may be considered indirectly synchronized with each other, facilitating sidelink communication. However, in some cases, a GNSS signal may be unavailable or unreliable and synchronizing UEs 115 indirectly via GNSS may not be feasible.

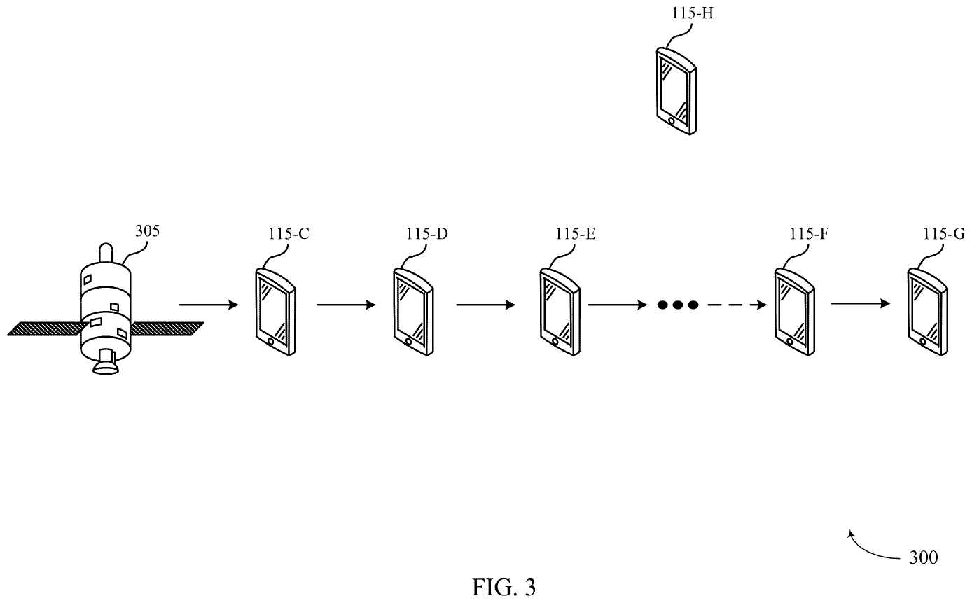

In some examples, a UE 115 may perform a sidelink synchronization procedure based on sidelink SSB transmission from another UE 115, as described further with respect to FIG. 3. That is, a UE 115 may act as a synchronization source for another UE 115. For example, a UE 115-b may be unable to detect GNSS signals (e.g., in accordance with a type or complexity of the UE) and instead may rely on sidelink SSB transmissions 205 from the UE 115-a, which may be synchronized with the GNSS, to be synchronized. This process may be specified (e.g., standardized). The synchronization procedure may ensure that all UEs 115 participating in sidelink communication may be synchronized, even without direct or indirect GNSS time, frequency, or both (time/frequency) resources available. The synchronization procedure may also ensure that UEs 115 follow similar synchronization procedures (e.g., behave consistently when performing synchronization).

In some cases, a UE 115, such as the UE 115-a, may not detect any GNSS signals, sidelink SSBs, or reliable sidelink SSBs. That is, there may not be a suitable signal for the UE 115-a to use for synchronization. Instead, the UE 115-a may act as an independent synchronization reference, such as by using an internal clock to determine timing of the transmission of sidelink SSBs 205. That is, the UE 115-a may transmit sidelink SSBs 205 for other UEs 115 to use in synchronization. This may generate a local synchronization reference, ensuring all UEs 115 in an area (e.g., environment, vicinity) may be able to perform sidelink communications.

In some cases, the UE 115-a may transmit the sidelink SSBs 205, and the sidelink SSBs 205 may include a sidelink synchronization signal (SLSS) identifier (ID). The SLSS ID may be a combination of a sidelink primary synchronization signal (PSS) ID and a sidelink secondary synchronization signal (SSS) ID. The UE 115-a may transmit the sidelink SSBs 205 with a first SLSS ID when acting as an independent synchronization reference, and may transmit the sidelink SSBs 205 with a second SLSS ID when not acting as an independent synchronization reference. For example, the UEs 115 that may receive the sidelink SSBs 205 may determine whether the sidelink SSBs 205 may be from an independent synchronization reference based on the SLSS ID. In some examples, the UE 115-a may change or select a new SLSS ID when the UE 115-a becomes an independent synchronization reference.

In some examples, the UE 115-a may detect sidelink SSBs, such as sidelink SSB transmissions 210, from the UE 115-b. The UE 115-a may determine whether to become an independent synchronization reference, rather than synchronizing with the UE 115-b, based on the reliability (e.g., strength, power) of the sidelink SSBs. That is, a threshold value may be defined, such as a threshold reference signal received power (RSRP), associated with the detection of the sidelink SSB transmissions 210 at the UE 115-a. A parameter (e.g., power offset), such as an RRC parameter (e.g., sl-SyncRefMinHyst), may be adjusted to change the threshold value at which the UE 115-a may determine to act as an independent synchronization reference. In some cases, the power offset may be a static or fixed value and may be preconfigured at the UE 115-a. All UEs 115 may have the same preconfigured value. In some examples, the value of the preconfigured power offset may change depending on a region or area (e.g., a value for the power offset in the United States may be different than in Europe). In some cases, the value of the power offset may be configured or indicated to the UE 115-a, such as via downlink 215 with a message 220. However, using a static value of the power offset for all UEs 115 in order to determine whether to become an independent synchronization reference may not be efficient. For example, some UEs 115 may have different capabilities or some UEs 115 may be in different environments, where specific values of the power offset may be more appropriate than other values.

In some wireless communications systems 200, the UE 115-a may be enabled or configured to select a value for the power offset. For example, the network entity 105-a may, via the message 220, configure the UE 115-a with multiple possible values for the power offset. The UE 115-a may select a value from the configured values, or select a value within a configured range, based on some factors or determination at the UE 115-a. A greater value for the power offset may correspond to a higher threshold for the sidelink SSB transmissions 210, meaning the UE 115-a may be relatively more likely to become an independent synchronization reference (e.g., relatively more aggressive in becoming an independent synchronization reference than the UE 115-b). On the other hand, a relatively smaller value may correspond to a UE 115-a that may be able to synchronize to a UE 115-b with a weaker sidelink SSB transmission 210 (e.g., may be relatively more conservative than the UE 115-b). This flexibility in modulating the value of the offset may allow the UE 115-a independence (e.g., autonomy, authority) to determine whether to become an independent synchronization reference. However, the UE 115-a may be ultimately conditioned on the absolute authority from network configuration or preconfiguration for the power offset. This may allow most UEs 115 to continue to follow normal procedures for synchronization, while allowing the UE 115-a to determine a value for the power offset.

In some cases, the value of the power offset may be selected from a preconfigured set of candidate values that is provided to the UE, such as by the network entity 105-a. For example, a set of candidate power offsets may be standardized or defined, and the network entity 105-a may signal to the UE 115-a a subset of these candidate power offsets, or a range of candidate values within the standardized set of candidate values for use by the UE 115-a. In some cases, the candidate values of the power offset may not include set numeric values (e.g., 0/3/6/9/12 dB), and instead reflect ranges of power offsets (e.g., one candidate being the range from 0 to 3 dB, another candidate being the range from 3 to 6 dB, another candidate being the range from 6 to 9 dB, and so forth). Additionally, or alternatively, the candidate values may contain negative values. That is, the UE 115-a may, in some scenarios, be able to reliably detect sidelink SSBs even when a measured RSRP is lower than a defined RSRP value. Configuration of the parameter values may be indicated in message 220 as part of a parameter (e.g., SL-SyncConfig) with values or ranges indicated by parameters, such as a minimum value (e.g., sl-SyncRefMinHystMin) or maximum value (sl-SyncRefMinHystMax).

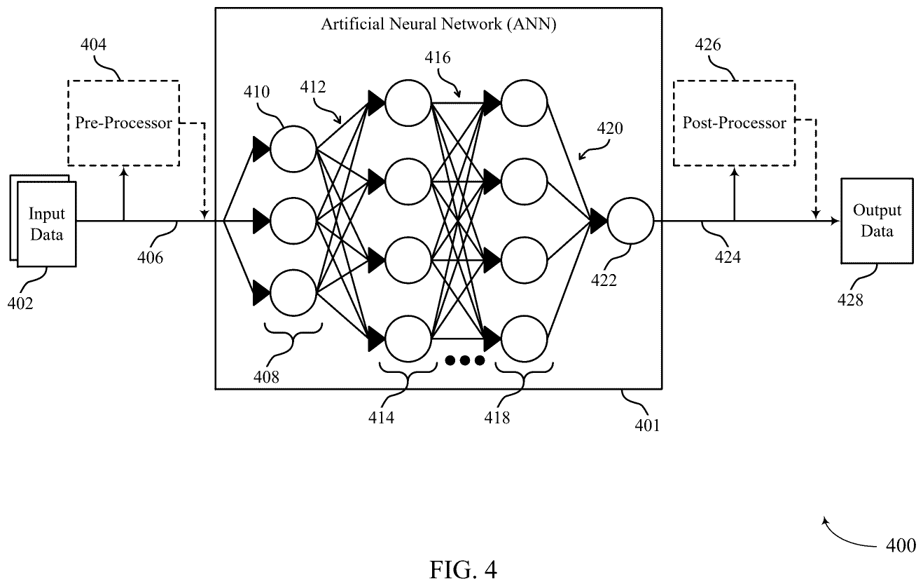

In some cases, the UE 115-a may be capable of leveraging local processing to determine a value for the power offset or to determine whether to act as an independent synchronization reference. For example, the UE 115-a may have an AI/ML capability. In some examples, the UE 115-a may use an AI/ML model to determine a value for the power offset based on the configuration, as described further with reference to FIG. 4. That is, the UE 115-a may be capable of using an AI/ML model to determine whether to become an independent synchronization reference or to transmit sidelink SSB transmissions 205 based on received sidelink SSBs 210 from the UE 115-b. For example, UE 115-a with an AI/ML capability, or some other systems (e.g., AI-native future-G systems), may select a value from the preconfigured range or set of values for the power offset by performing an inference using an AI/ML model, which may output a value for the offset. Additionally, or alternatively, the AI/ML model may output an indication of whether the UE 115-a should act as an independent synchronization reference, rather than, or in addition to, indicating a value of the power offset.

FIG. 3 shows an example of a chain diagram 300 that supports independent synchronization reference determination for sidelink synchronization in accordance with one or more aspects of the present disclosure. The chain diagram 300 may implement, or be implemented by, aspects of the wireless communications system 100 and 200. For example, the chain diagram 300 may include one or more UEs 115, including at least the UEs 115-b, 115-c, 115-d, 115-e, 115-f, and 115-g, which may be examples of corresponding devices as described herein, including with reference to FIG. 1 and FIG. 2. The techniques described herein in the context of the chain diagram 300 may support a UE 115-a to determine to become an independent synchronization reference based on selecting a value of a power offset.

In some wireless communications system, a UE 115-c may be able to synchronize with a GNSS 305. For example, a UE 115-c may directly synchronize with the GNSS 305. When the UE 115-c is directly synchronized to the GNSS 305, the UE 115-c may transmit sidelink SSBs to propagate time/frequency references from the GNSS to other UEs 115. Each sidelink connection over which the SSB propagates may be considered a “hop”. For example, the UE 115-c may transmit the sidelink SSBs to the UE 115-d over a first hop to enable the UE 115-d to synchronize with the UE 115-c. Similarly, the UE 115-d may transmit sidelink SSBs to the UE 115-d over a second hop to enable the UE 115-e to synchronize with the UE 115-d (and by extension, with the UE 115-c).

If a UE 115, such as a UE 115-h, lacks a capability to detect a GNSS signal or otherwise fails to detect a GNSS signal, the UE 115-h may search for sidelink SSBs transmitted by other UEs 115. Sidelink SSBs transmitted by different UEs 115 may be associated with different priorities. For example, the sidelink SSBs transmitted by the UE 115-c may be of a relatively highest priority, as the UE 115-c may be directly synchronized with the GNSS. Sidelink SSBs transmitted by the UE 115-d may be of a second highest priority, as the UE 115-d may be two hops from the GNSS. For example, if the UE 115-h is looking for a synchronization source, the UE 115-h may first attempt to synchronize with the GNSS, and if unsuccessful or unable to synchronize with the GNSS, the UE 115-h may search for SSBs associated with the highest priority, such as the SSBs transmitted by the UE 115-c. If the UE 115-h is unable to detect reliable SSBs associated with the highest priority, the UE 115-h may attempt to detect and synchronize with SSBs associated with a next highest priority, such as the SSBs transmitted by the UE 115-d. In some examples, sidelink SSBs beyond the UE 115-d, or UEs 115 associated with a third hop or higher, may be of the same priority. That is, the UE 115-h trying to synchronize may not be able to distinguish between, or may not assign different priorities to, sidelink SSBs associated with the UE 115-e and the UE 115-f, although the UE 115-f may be further down the chain of UEs 115.

As the chain grows, errors may propagate through the synchronization process. That is, the time/frequency reference may be propagated from the GNSS for many hops before reaching a UE 115 that may be trying to synchronize. With each additional hop, a random amount of time and frequency error may be introduced due to drift as well as errors related to detecting the sidelink SSBs. Thus, error may be accumulated and compounded as the time/frequency reference propagates across hops. That is, sidelink SSBs transmitted from the UE 115-f may be much less accurate than those of the UE 115-e, although the UE 115 trying to synchronize may not be able to distinguish between the two.

However, the UE 115 attempting to synchronize may be able to detect an accumulated error in received SSBs. For example, the UE 115 may detect a sidelink SSB in one sidelink SSB resource of each SSB resource period. In some examples, the accumulated time/frequency error may be reflected as a larger variation of in the time/frequency reference in one sidelink SSB resource across SSB resource periods. For example, the strongest SSB signal path in two different periods may be from different UEs 115, which may be due to a high mobility of the UEs 115 within the system. The time/frequency references from these different UEs 115 may be different or variable if there is accumulated error in a system. Additionally, or alternatively, when a UE 115 may detect sidelink SSBs from multiple SSB resources within a synchronization resource period, the UE 115 may observe greater difference in the time/frequency reference between the multiple SSB resources. In some aspects (e.g., modem implementations), the UE 115 may be limited, or may be equipped to handle a limited variation of the time/frequency reference, particularly a time reference, across sidelink SSB resources or resource periods. For example, the UE 115 may be configured with some timing (e.g., connected search timing) established based on a sidelink SSB period that may be used as a reference for detecting sidelink SSB in a next period. That is, initial acquisition sidelink detection may not be used for detecting all SSBs, such as during ongoing sidelink communication, which may lead to failure to detect sidelink SSBs if the time reference is not accurate. That is, if variation in the time/frequency reference is beyond a limit, or reaches a threshold, the UE 115 may miss detection of the sidelink SSB, which may lead to unreliable sidelink synchronization. Thus, synchronizing to a “far away” source, or a source far in the chain, such as the UE 115-f, may degrade the stability of sidelink synchronization.

When a GNSS signal is not available and sidelink SSB transmissions are not available or are not reliable, such as due to a UE 115-f being relatively far away (such as more than two hops away) from the GNSS 305 in a synchronization chain, the UE 115-f may determine to become an independent synchronization reference and transmit sidelink SSBs according to its own internal timing, which may be determined by an internal clock or some other implementation at the UE 115-f. A signal, such as a sidelink SSB signal or a GNSS signal, may be deemed unreliable if the RSRP of the signal fails to satisfy a threshold. The threshold may be defined by a power offset (e.g., sl-SyncRefMinHyst), as described further with reference to FIG. 2. For example, some power offset may be defined that may be applied to an RSRP value in order to define a threshold. If the RSRP of a sidelink SSB or another signal falls below the threshold defined by the RSRP value and the power offset, the signal may be deemed unreliable. For example, the UE 115-f may detect unreliable sidelink SSBs or may detect no sidelink SSBs at all. The UE 115-f may determine to become an independent synchronization reference, transmitting sidelink SSBs according to internal timing. The UE 115-g may synchronize with the sidelink SSBs of the UE 115-f.

In some aspects, the value of the power offset may be static or preconfigured. That is, the UE 115-f may have little control over whether to become an independent synchronization reference. However, in other aspects, the UE 115-f may determine a value for a power offset from a minimum RSRP dynamically, such that the UE 115-f may determine whether to become an independent synchronization reference based on a capability of the UE 115-f and measured environmental factors. For example, a network entity may configure the UE 115-f with a range of possible values for the power offset. The range may be a set of possible values or a range indicated by a maximum and minimum value. In some aspects, the UE 115-f may use an AI/ML model, as described further with reference to FIG. 4, to determine whether to become an independent synchronization reference. For example, the UE 115-f may measure some environmental factors, such as an RSRP of a received sidelink SSB, a SINR of a received sidelink SSB, a difference in time or frequency between detections of a sidelink SSB from a same source (e.g., based on an SLSSID), or the like. The UE 115-f may input the range of values for the power offset and the measured environmental factors into the AI/ML model. In some examples, the AI/ML model may indicate a value for the power offset, and the UE 115-f may select a value for the power offset within the range of values in accordance with the indicated value. In other examples, the AI/ML model may indicate for the UE 115-f to act as an independent synchronization reference. The UE 115-f may transmit a sidelink SSB as an independent synchronization reference in accordance with the output of the AI/ML model.

FIG. 4 shows an example of a block diagram 400 that supports independent synchronization reference determination for sidelink synchronization in accordance with one or more aspects of the present disclosure. The block diagram 400 may be an example of a AI/ML model represented by an artificial neural network (ANN) 401. The block diagram 400 may implement, or be implemented by, aspects of the wireless communications system 100 and 200, and the chain diagram 300. The techniques described herein in the context of the chain diagram 300 may support a UE 115-a to determine to become an independent synchronization reference based on selecting a value of a power offset parameter using an AI/ML model.

ANN 401 (e.g., AI/ML model) may receive input data 406 which may include one or more bits of data 402, preprocessed data output from preprocessor 404 (optional), or some combination thereof. Here, data 402 may include training data, verification data, application-related data, or the like, based, for example, on the stage of deployment of ANN 401. Preprocessor 404 may be included within ANN 401 in some other aspects. Preprocessor 404 may, for example, process all or a portion of data 402 which may result in some of data 402 being changed, replaced, deleted, etc. In some aspects, preprocessor 404 may add additional data to data 402. In some aspects, the preprocessor 404 may be a ML model, such as an ANN.

A UE may implement the ANN 401 to select a value for a power offset for determining whether to become an independent synchronization reference or for determining whether a UE may act as a sidelink synchronization source, as described with reference to FIG. 2 and FIG. 3. The ANN 401 may receive input data 402. The input data 402 may include an indicated, specified, or preconfigured range or set of candidate values for the power offset (e.g., sl-SyncRefMinHyst). Additionally, or alternatively, the input data 402 may include a measured synchronization signal RSRP, a measured SINR, or both of a detected SLSSID from multiple (e.g., 2 or 3) synchronization resources within a synchronization period (e.g., from a detected sidelink SSB, measured from a physical shared broadcast channel (PSBCH) demodulation reference signal (DMRS)), such as the strongest measured RSRP or highest measured SINR. Additionally, or alternatively, the input data 402 may include a measured synchronization signal RSRP, a measured SINR, or both of a detected SLSSID from multiple (e.g., 2 or 3) synchronization resources, such as the strongest measured RSRP or highest measured SINR. Additionally, or alternatively, the input data 402 may include a measured RSRP, measured SINR, or both of the same detected SLSSID across multiple synchronization resource periods (e.g., reflecting variation in measurements over time).

Additionally, or alternatively, the input data 402 may include the detected SLSSID, which may correspond to measurements also being used as input data 402. Additionally, or alternatively, the input data 402 may include a power-delay profile or channel impulse response of a detected SLSSID (e.g., measured from the PSBCH DMRS). For example, the input data 402 may include power and relative delay of a first quantity (e.g., N) of channel paths, power and relative delay of channel paths in a time window (e.g., T) (e.g., starting from the first channel path), or the like. Additionally, or alternatively, the input data 402 may include difference of time, frequency, or both of the same detected SLSSID across two (or more) synchronization resource periods on the same synchronization resource (e.g., first synchronization resource of two adjacent periods), within a synchronization period, or any combination thereof.

ANN 401 includes at least one first layer 408 of artificial neurons 410 to process input data 406 and provide resulting first layer data via connections or “edges” such as edges 412 to at least a portion of at least one second layer 414. Second layer 414 processes data received via edges 412 and provides second layer output data via edges 416 to at least a portion of at least one third layer 418. Third layer 418 processes data received via edges 416 and provides third layer output data via edges 420 to at least a portion of a final layer 422 including one or more neurons to provide output data 424. All or part of output data 424 may be further processed in some manner by (optional) post-processor 426. Thus, in some examples, ANN 401 may provide output data 428 that is based on output data 424, post-processed data output from post-processor 426, or some combination thereof.

Post-processor 426 may be included within ANN 401 in some other aspects. Post-processor 426 may, for example, process all or a portion of output data 424 which may result in output data 428 being different, at least in part, to output data 424, as result of data being changed, replaced, deleted, etc. In some aspects, post-processor 426 may be configured to add additional data to output data 424. In this example, second layer 414 and third layer 418 represent intermediate or hidden layers that may be arranged in a hierarchical or other like structure. Although not explicitly shown, there may be one or more further intermediate layers between the second layer 414 and the third layer 418. In some aspects, the post-processor 426 may be a ML model, such as an ANN.

The output data 428 may include values for the power offset (e.g., sl-SyncRefMinHyst), an indication of whether a UE should act as independent synchronization reference, or an indication of whether another UE may be used as a synchronization source for the UE. In some examples, a UE with an AI/ML capability may use the ANN 401 to select a value for the power offset from the preconfigured range or set of values for the power offset, which may be configured by a network entity, as described further with reference to FIG. 2. The UE may perform the selection by performing an inference using the AI/ML model, where the AI/ML model output data 428 may include a value for the power offset. The UE may then determine whether to become an independent synchronization reference based on the output data 428. That is, the ANN 401 may output a value for the power offset, and the UE may determine whether to become an independent synchronization reference based on the output data 428, one or more RSRP measurements, and one or more minimum RSRP requirements, or thresholds. For example, the UE may determine if the measured RSRP from a detected SLSSID exceeds the minimum RSRP requirement or threshold by the value of the power offset (e.g., sl-SyncRefMinHyst). If it does, a UE associated with the SLSSID may be determined to be a candidate UE to be synchronized with (e.g., SyncRef UE). If not, the UE performing the measurements may determine to act as independent synchronization reference.

In other examples, the output data 428 may include a decision on whether the UE associated with the measured RSRP may be a candidate synchronization reference UE (e.g., SyncRef UE). That is, the output data 428 may indicate whether a measured UE should be used as a synchronization source or whether the measuring UE should act as an independent synchronization reference (e.g., providing a classification for the UE). One or more RSRP measurements associated with sidelink SSBs, or received synchronization signals, may be part of the input data 402 for the ANN 401 that may output such a determination. For example, for a measured RSRP from a detected SLSSID, the UE may generate an inference using an AI/ML model to determine whether the UE associated with the SLSSID is a candidate for synchronization (e.g., SyncRef UE). The measuring UE may become independent synchronization reference if no candidate UE for synchronization may be identified.

The structure and training of artificial neurons 410 in the various layers may be tailored to specific requirements of an application. Within a given layer such as first layer 408, second layer 414, or third layer 418 of ANN 401, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” artificial neurons of a next layer. Artificial neurons in such a layer may be activated by or be responsive to parameters such as the previously described weights and biases of ANN 401. The weights and biases of ANN 401 may be adjusted during a training process or during operation of ANN 401. The weights of the various artificial neurons may control a strength of connections between layers or artificial neurons, while the biases may control a direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 406. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 401, may be conducted using training data. Training data may include one or more datasets which ANN 401 may use to identify patterns or relationships. Training data may represent various types of information, including written, visual, audio, environmental context, operational properties, etc. During training, the parameters (such as the weights and biases) of artificial neurons 410 may be changed, such as to minimize or otherwise reduce a loss function or a cost function. A training process may be repeated multiple times to fine-tune ANN 401 with each iteration.

ANN 401 or other ML models may be implemented in various types of processing circuits along with memory and applicable instructions therein. For example, general-purpose hardware circuits, such as, such as one or more central processing units (CPUs), one or more graphics processing units (GPUs), or suitable combinations thereof, may be employed to implement a model. In some aspects, one or more tensor processing units (TPUs), neural processing units (NPUs), or other special-purpose processors, field-programmable gate arrays (FPGAs), application-specific integrated circuits (ASICs), or the like may also be employed.

In example aspects, an ML model may be trained prior to, or at some point following, operation of the ML model, such as ANN 401, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In some instances, all or part of the training data may originate in a user equipment (UE) or other device in a wireless communication system, or one or more network entities, or aggregated from multiple sources (such as a UE and a network entity/entities, one or more other UEs, the Internet, or the like). In another example, training data may be generated or collected online, offline, or both online and offline by a UE, network entity, or other device(s), and all or part of such training data may be transferred or shared (in real or near-real time), such as through store and forward functions or the like.

In some aspects, the AI/ML model, ANN 401, may be pretrained (e.g., trained offline) and preconfigured for the UE. That is, a network entity may send some indication or control signaling configuring the ANN 401. Additionally, or alternatively, the ANN 401 may be trained by a UE. that is, the UE may be preconfigured (e.g., RRC preconfiguration) with or may receive some indication or configuration of a “case model structure,” or default ANN 401, which may include an indication of input parameters, output parameters, quantity of layers, quantities of artificial neurons, or the like. The UE may use different parameters as key performance indicators (KPIs) in order to train, improve, or use (e.g., optimize) the AI/ML model and the ANN 401. Some of these parameters may be configured, preconfigured, or specified by a rule (e.g., standardized) at the UE. For example, a difference in time reference frequency reference, or both of a detected SLSSID across two or more synchronization resource periods on the same synchronization resource (e.g., the first synchronization resource of two adjacent periods) may be used as a KPI. That is, when a synchronization resource period is of a duration (e.g., 160 ms), if a difference of timing from a detected sidelink SSB in the same resource across two periods is the same as the duration of the period (e.g., 160 ms), then the different of the time reference may be zero. If the difference in timing from the detected sidelink SSB in the same resource across two periods is some amount longer than the duration of the period (e.g., 160.1 ms), then the difference of the time reference may be that amount (e.g., 0.1 ms). Additionally, or alternatively, the difference in time, frequency, or both for a same detected SLSSID between multiple synchronization resources (e.g., two, three if configured) within a synchronization period may be a KPI. Additionally, or alternatively, an occurrence of a miss detection of a sidelink SSB in a sidelink SSB period after detecting a sidelink SSB in a previous sidelink SSB period may be used as a KPI. Additionally, or alternatively, a quantity or ratio of miss detections in a configured or preconfigured duration may be used as a KPI.

In one example, after propagating a sidelink synchronization reference for many hops form a source, such as a GNSS, the time reference, frequency reference or both determined from the detected SSB from different SSB resources or periods may appear scattered, or variable, as described further with reference to FIG. 3. If there is no error introduced in a synchronization procedure, then time references determined from a sidelink SSB on the same resource across multiple synchronization resource periods (e.g., the first resource of each period) may be aligned. That is, the time reference determined form two adjacent sidelink SSB periods should match a sidelink SSB periodicity (e.g., 160 ms). However, in the case where a hop count may be large or error may be introduced, the difference in time references determine from the sidelink SSB across two adjacent periods might not match the periodicity. IF the difference in the time reference (or a frequency reference) is large enough, the UE may not be able to detect the sidelink SSB. That is, miss detection of the sidelink SSB may occur, since the UE may rely on the timing reference to detect SSBs (e.g., connected search, the UE may not support initial acquisition detection after connection). The difference in the time reference from different sidelink SSB periods may be used as a target KPI. The ANN 401 may select a value for the power offset such that the UE determines whether to become an independent synchronization reference based on the difference in the time reference being reasonable or below a threshold. For example, the AI/ML may select a power offset or indicate for a UE to use a sidelink SSB for synchronization based on the difference of time reference being smaller than a threshold, such as a cyclic prefix (CP) duration. Similarly, difference of time references, frequency reference, or both between multiple sidelink SSB resources within a period, or differences both within a period and across multiple periods, may be used as KPI.

In another example, the ANN 401 may use a quantity of miss detection occurrences as a KPI. That is, when a sidelink SSB is detected in a sidelink SSB resource in a current sidelink SSB period, the UE may detect the sidelink SSB in the next sidelink SSB period based on some time window form the sidelink SSB timing reference determined from the current sidelink SSB period. As scattering of the time reference increases, such as with higher hop count, the sidelink SSB may not be detected in a next period, resulting in a miss detection. The miss detection may be used as a target KPI for the power offset selection or the synchronization source determination. That is, the ANN 401 may determine a power offset value or synchronization source classification such that there are no miss detections of sidelink SSBs, not consecutive miss detections across a sidelink SSB period, no miss detections greater than a quantity of sidelink SSB occasions out of a quantity of sidelink SSB periods, or the like.

In some cases, the UE may report a KPI value to a network entity. For example, the UE may report the difference of time references, an occurrence of miss detection, a quantity of miss detections, or any combination thereof.

Offline training may refer to creating and using a static training dataset, such as, in a batched manner, whereas online training may refer to a real-time collection and use of training data. For example, an ML model at a network device (such as, a UE) may be trained or fine-tuned using online or offline training. For offline training, data collection and training can occur in an offline manner at the network side (such as, at a base station or other network entity) or at the UE side. For online training, the training of a UE-side ML model may be performed locally at the UE or by a server device (such as, a server hosted by a UE vendor) in a real-time or near-real-time manner based on data provided to the server device from the UE. In some instances, all or part of the training data may be shared within in a wireless communication system, or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, re-training it on the data, or using different optimization techniques, etc.

As part of a training process, parameters, such as the KPIs discussed herein, affecting the functioning of the artificial neurons and layers may be adjusted. For example, backpropagation techniques may be used to train an ANN 401 by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases as needed to reduce or minimize the loss function which should improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust a learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an on-going training process early, such as when a performance of the model using a validation dataset starts to degrade.

Another example technique includes data augmentation to generate additional training data by applying transformations to all or part of the training information. A transfer learning technique may be used which involves using a pretrained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN 401 is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that may be transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment, and less aggressively prune the model for use in a high-power or high-bandwidth environment. In some example aspects, pruning techniques also may be applied to training data, for example, to remove outliers. In some aspects, preprocessing techniques directed to all or part of a training dataset may improve model performance or promote faster convergence of a model. For example, training data may be preprocessed to change or remove unnecessary data, extraneous data, incorrect data, or otherwise identifiable data. Such preprocessed training data may, for example, lead to a reduction in potential overfitting, or otherwise improve the performance of the trained model.

One or more of the example training techniques presented above may be employed as part of a training process. Some example training processes that may be used to train an ANN include supervised learning, unsupervised learning, semi-supervised learning, and reinforcement learning technique. With supervised learning, a model is trained on a labeled training dataset, wherein the input data may be accompanied by a correct or otherwise acceptable output. With unsupervised learning, a model is trained on an unlabeled training dataset, such that the model may learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize a behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of a ML model, without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large quantity of wireless devices in a network, such as distributed wireless communication nodes, smartphones, or internet-of-things (IoT) devices, to improve the network's performance and efficiency. With federated learning, a user equipment (UE) or other device may receive a copy of all or part of a global or shared model and perform local training on the local model using locally available training data. The UE may provide update information regarding the locally trained model to one or more other devices (such as a network entity or a server) where the updates from other-like devices (such as other UEs) may be aggregated and used to provide an update to global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some aspects, one or more devices or services may support processes relating to a ML model's usage, maintenance, activation, reporting, or the like. In some instances, all or part of a dataset or model may be shared across multiple devices, to provide or otherwise augment or improve processing. In some examples, signaling mechanisms may be utilized at various nodes of wireless network to signal the capabilities for performing specific functions related to ML model, support for specific ML models, capabilities for gathering, creating, transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some aspects, model deployment may occur jointly or separately at various network levels, such as, a UE, a network entity such as a base station, or a disaggregated network entity such as a central unit (CU), a distributed unit (DU), a radio unit (RU), or the like.

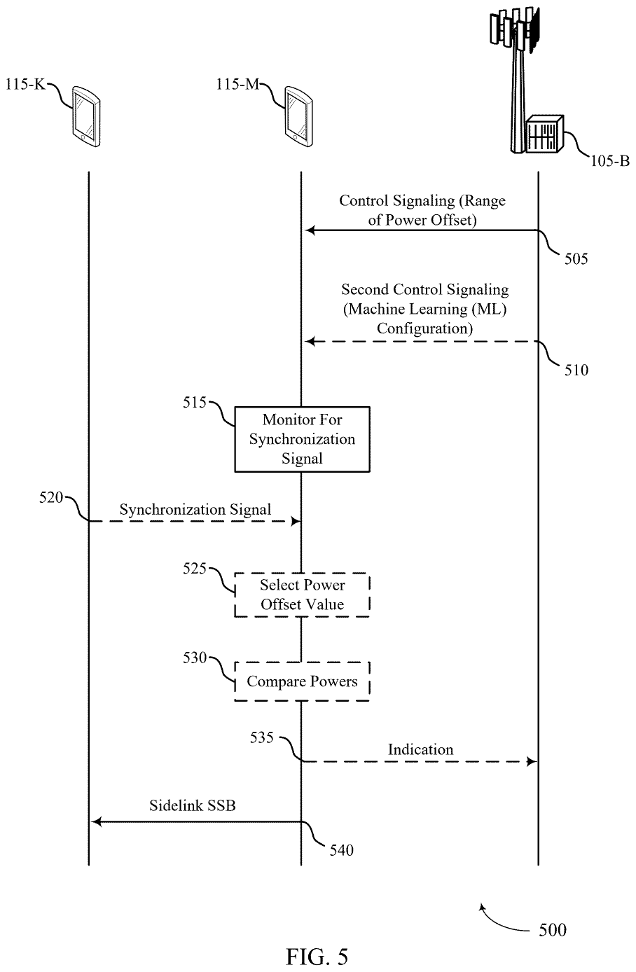

FIG. 5 shows an example of a process flow 500 that supports independent synchronization reference determination for sidelink synchronization in accordance with one or more aspects of the present disclosure. The process flow 500 may implement, or be implemented by, aspects of the wireless communications system 100 or 200, the chain diagram 300, or the block diagram 400. For example, the process flow 500 may include one or more network entities 105 and UEs 115, including at least the network entity 105-b and the UEs 115-m and 115-k, which may be examples of corresponding devices as described herein, including with reference to FIGS. 1, 2, and 3. The techniques described herein in the context of the process flow 500 may support a UE 115-a to determine to become an independent synchronization reference based on selecting a value of a power offset.

At 505, the UE 115-m may receive, and the network entity 105-b may output, control signaling that may indicate a range of a power offset (e.g., parameter, sl-SyncRefMinHyst) associated with a synchronization signal. In some cases, the range of the power offset may include a maximum value and a minimum value, one or more candidate values for the power offset, or any combination thereof.

In some aspects, at 510, the UE 115-m may receive second control signaling that may indicate a configuration for an ML model (e.g., AI/ML model), as described with respect to FIG. 4. Additionally, or alternatively, the UE 115-m may receive second control signaling that may indicate one or more parameters for training the ML model. The UE 115-m may train the ML model in accordance with the one or more parameters and in accordance with measured values associated with the one or more parameters. Additionally, or alternatively, the UE 115-m may receive second control signaling that may indicate one or more environmental parameters (e.g., KPIs) associated with a measurement procedure at the UE 115-m, where an input for the ML model may be based on the one or more environmental parameters.

At 515, the UE 115-m may monitor a wireless channel for the synchronization signal (e.g., sidelink SSB). For example, the UE 115-m may monitor a wireless channel for the synchronization signal from one or more other UEs, including UE 115-k.

In some aspects, at 520, the UE 115-m may receive the synchronization signal based on monitoring the wireless channel. In some cases, the UE 115-k may transmit the synchronization signal at 520.

In some aspects, at 525, the UE 115-m may select a value of the power offset in accordance with the range of the power offset and in accordance with one or more measured environmental parameters. For example, the UE 115-m may select the value of the power offset, where the value of the power offset may be within the range of the power offset. The one or more measured environmental parameters may be associated with monitoring the wireless channel for the synchronization signal. In some cases, the one or more measured environmental parameters (e.g., KPIs) may include one or more of: a received signal strength (e.g., RSRP), a SINR, a SLSSID, a power delay profile, a channel impulse response, a difference in time between multiple synchronization signals, a difference in frequency between the multiple synchronization signals, or any combination thereof, where the multiple synchronization signals may include the synchronization signal. For example, the UE 115-m may select the value of the power offset based on one or more measured environmental parameter associated with the synchronization signal satisfying a threshold or satisfying a condition. In some cases, the one or more measured environmental parameters and the range of the power offset may include input parameters for a ML (e.g., AI/ML) model, such as input data 402 described with respect to FIG. 4.

In some aspects, at 530, the UE 115-m may compare a power associated with the synchronization signal, received at 520, to a threshold power. The threshold power may be associated with the power offset, where the power offset may be associated with the range of the power offset. Transmission of the sidelink SSB, as described at 540, may be based on the comparison (e.g., the comparing). In some cases, the comparison may be based on selecting a value for the power offset, as described further at 525. For example, at 525, the UE 115-m may select a value for the power offset. In some examples, the UE 115-m may select the value for the power offset such that the value may be within the range of the power offset. The threshold power may be the value of the power offset added to a minimum power threshold, and comparing the power associated with the synchronization signal to the threshold power may thus be based on selecting the value for the power offset.

In some aspects, at 535, the UE 115-m may transmit an indication of the one or more measured environmental parameters.

At 540, the UE 115-m may transmit a sidelink SSB as an independent synchronization reference based on the monitoring, as described further at 515, and the range of the power offset associated with the synchronization signal. For example, the UE 115-m may transmit the sidelink SSB based on selecting the value of the power offset from the range of the power offset and comparing the power of the synchronization signal to the threshold power associated with the value of the power offset. In some cases, the UE 115-k may obtain the sidelink SSB at 540. Additionally, or alternatively, other UEs 115 may obtain the sidelink SSB. That is, the UE 115-m may act as independent synchronization reference for at least the UE 115-k. In some cases, the UE 115-m may transmit the sidelink SSB based on an internal timing associated with an internal clock at the UE 115-m. For example, the UE 115-m may determine some timing with which to transmit the sidelink SSB, which may be based on the internal clock. That is, the UE 115-m may periodically transmit the sidelink SSB, and determining the periodicity may be based on some UE 115-m implementation, rather than an external source. For example, the UE 115-m may use an internal clock to determine an internal timing for the transmission of the SSBs.

In some cases, the UE 115-m may transmit the sidelink SSB at 540 based on an output of a ML model (e.g., AI/ML model). In some examples, the output of the ML model may include a value of the power offset in accordance with the range of the power offset. Transmission of the sidelink SSB at 540 may be based on the value of the power offset. For example, the ML model may output a value of the power offset, and the UE 115-m may transmit the sidelink SSB based on a power associated with the synchronization signal failing to exceed a threshold power, where the threshold power may be associated with the value of the power offset. In some examples, the output of the ML model may include an indication to transmit the sidelink SSB at 540 as an independent synchronization reference. Transmission of the sidelink SSB may be based on the indication. For example, the ML model may output an indication that the UE 115-m may transmit the sidelink SSB, and the UE 115-m may transmit the sidelink SSB based on the indication from the ML model.

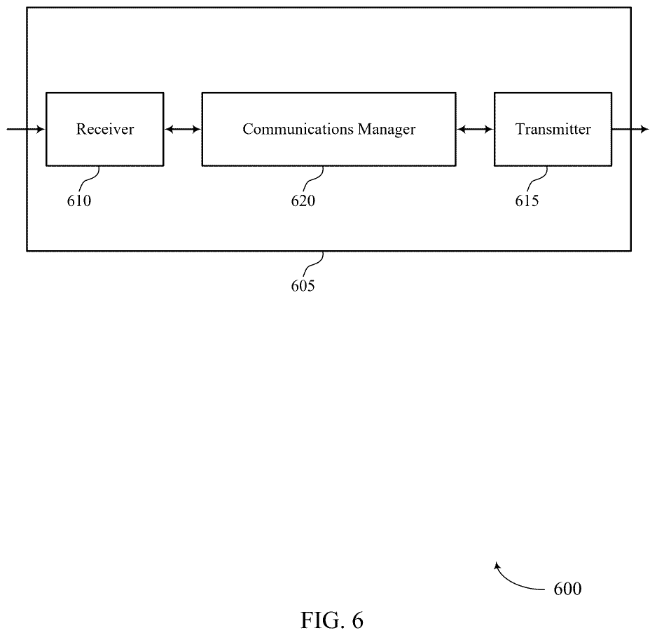

FIG. 6 shows a block diagram 600 of a device 605 that supports independent synchronization reference determination for sidelink synchronization in accordance with one or more aspects of the present disclosure. The device 605 may be an example of aspects of a UE 115 as described herein. The device 605 may include a receiver 610, a transmitter 615, and a communications manager 620. The device 605, or one or more components of the device 605 (e.g., the receiver 610, the transmitter 615, the communications manager 620), may include at least one processor, which may be coupled with at least one memory, to, individually or collectively, support or enable the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to independent synchronization reference determination for sidelink synchronization). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to independent synchronization reference determination for sidelink synchronization). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations or components thereof may be examples of means for performing various aspects of independent synchronization reference determination for sidelink synchronization as described herein. For example, the communications manager 620, the receiver 610, the transmitter 615, or various combinations or components thereof may be capable of performing one or more of the functions described herein.

In some examples, the communications manager 620, the receiver 610, the transmitter 615, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 620, the receiver 610, the transmitter 615, or various combinations or components thereof may be implemented in code (e.g., as communications management software or firmware) executed by at least one processor (e.g., referred to as a processor-executable code). If implemented in code executed by at least one processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications in accordance with examples as disclosed herein. For example, the communications manager 620 is capable of, configured to, or operable to support a means for receiving control signaling that indicates a range of a power offset associated with a synchronization signal. The communications manager 620 is capable of, configured to, or operable to support a means for monitoring a wireless channel for the synchronization signal. The communications manager 620 is capable of, configured to, or operable to support a means for transmitting a sidelink SSB as an independent synchronization reference based on the monitoring and the range of the power offset associated with the synchronization signal.

By including or configuring the communications manager 620 in accordance with examples as described herein, the device 605 (e.g., at least one processor controlling or otherwise coupled with the receiver 610, the transmitter 615, the communications manager 620, or a combination thereof) may support techniques for improved communication reliability, reduced latency, and more efficient utilization of communication resources.

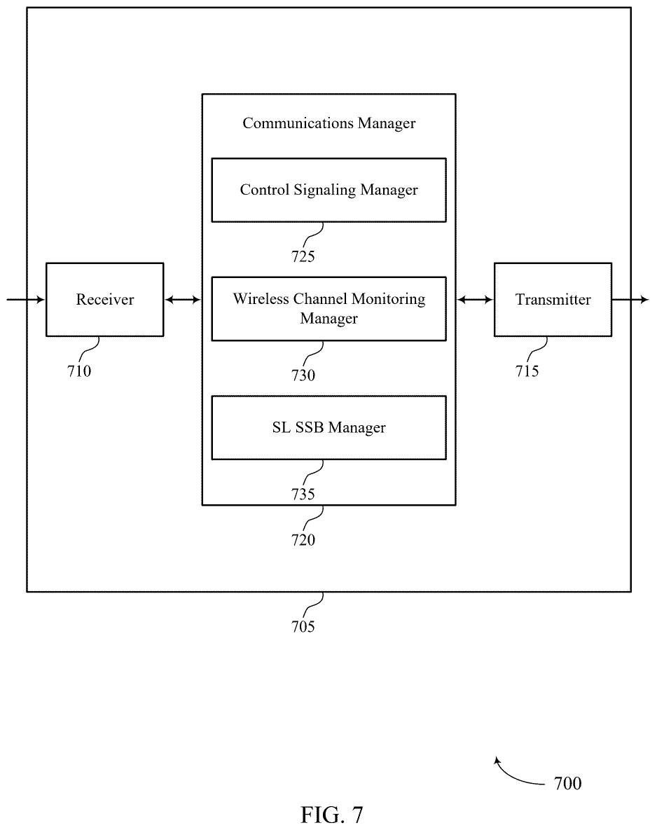

FIG. 7 shows a block diagram 700 of a device 705 that supports independent synchronization reference determination for sidelink synchronization in accordance with one or more aspects of the present disclosure. The device 705 may be an example of aspects of a device 605 or a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to support the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to independent synchronization reference determination for sidelink synchronization). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to independent synchronization reference determination for sidelink synchronization). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of independent synchronization reference determination for sidelink synchronization as described herein. For example, the communications manager 720 may include a control signaling manager 725, a wireless channel monitoring manager 730, an SL SSB manager 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. The control signaling manager 725 is capable of, configured to, or operable to support a means for receiving control signaling that indicates a range of a power offset associated with a synchronization signal. The wireless channel monitoring manager 730 is capable of, configured to, or operable to support a means for monitoring a wireless channel for the synchronization signal. The SL SSB manager 735 is capable of, configured to, or operable to support a means for transmitting a sidelink SSB as an independent synchronization reference based on the monitoring and the range of the power offset associated with the synchronization signal.

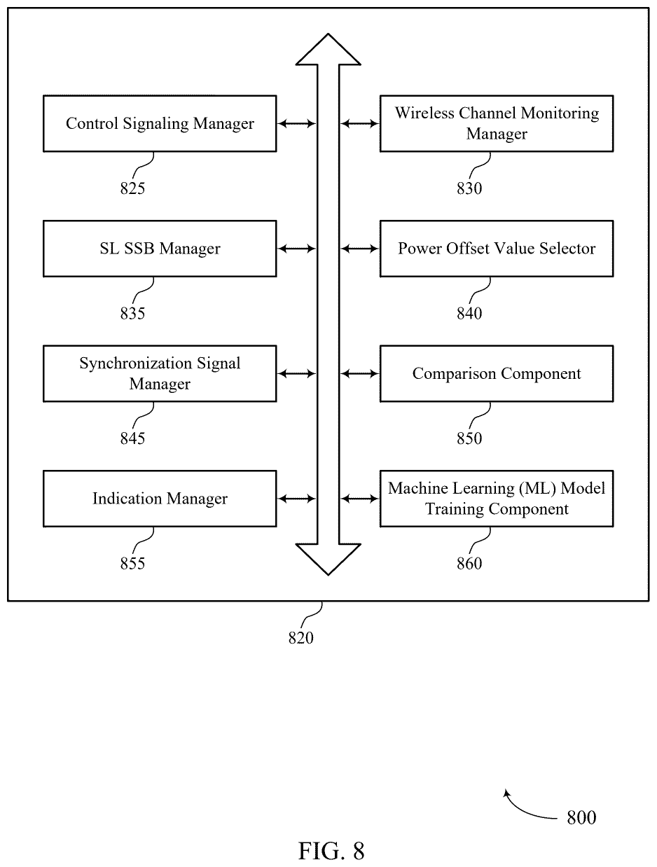

FIG. 8 shows a block diagram 800 of a communications manager 820 that supports independent synchronization reference determination for sidelink synchronization in accordance with one or more aspects of the present disclosure. The communications manager 820 may be an example of aspects of a communications manager 620, a communications manager 720, or both, as described herein. The communications manager 820, or various components thereof, may be an example of means for performing various aspects of independent synchronization reference determination for sidelink synchronization as described herein. For example, the communications manager 820 may include a control signaling manager 825, a wireless channel monitoring manager 830, an SL SSB manager 835, a power offset value selector 840, a synchronization signal manager 845, a comparison component 850, an indication manager 855, an ML model training component 860, or any combination thereof. Each of these components, or components or subcomponents thereof (e.g., one or more processors, one or more memories), may communicate, directly or indirectly, with one another (e.g., via one or more buses).

The communications manager 820 may support wireless communications in accordance with examples as disclosed herein. The control signaling manager 825 is capable of, configured to, or operable to support a means for receiving control signaling that indicates a range of a power offset associated with a synchronization signal. The wireless channel monitoring manager 830 is capable of, configured to, or operable to support a means for monitoring a wireless channel for the synchronization signal. The SL SSB manager 835 is capable of, configured to, or operable to support a means for transmitting a sidelink SSB as an independent synchronization reference based on the monitoring and the range of the power offset associated with the synchronization signal.

In some examples, the power offset value selector 840 is capable of, configured to, or operable to support a means for selecting a value of the power offset in accordance with the range of the power offset and in accordance with one or more measured environmental parameters, where the one or more measured environmental parameters are associated with monitoring the wireless channel for the synchronization signal.

In some examples, the one or more measured environmental parameters may include a received signal strength, a SINR, a SLSSID, a power delay profile, a channel impulse response, a difference in time between a set of multiple synchronization signals, a difference in frequency between the set of multiple synchronization signals, or any combination thereof, where the set of multiple synchronization signals includes the synchronization signal.

In some examples, the indication manager 855 is capable of, configured to, or operable to support a means for transmitting an indication of the one or more measured environmental parameters.

In some examples, the one or more measured environmental parameters and the range of the power offset include input parameters for a ML model.

In some examples, the synchronization signal manager 845 is capable of, configured to, or operable to support a means for receiving the synchronization signal based on monitoring the wireless channel. In some examples, the comparison component 850 is capable of, configured to, or operable to support a means for comparing a power associated with the synchronization signal to a threshold power, the threshold power associated with the power offset associated with the range of the power offset, where transmission of the sidelink SSB is based on the comparing.

In some examples, to support transmitting the sidelink SSB, the SL SSB manager 835 is capable of, configured to, or operable to support a means for transmitting the sidelink SSB based on an internal timing associated with an internal clock at the UE.

In some examples, the range of the power offset includes a maximum value and a minimum value, one or more candidate values for the power offset, or any combination thereof.

In some examples, to support transmitting the sidelink SSB, the SL SSB manager 835 is capable of, configured to, or operable to support a means for transmitting the sidelink SSB based on an output of a ML model.

In some examples, the output of the ML model includes a value of the power offset in accordance with the range of the power offset. In some examples, transmission of the sidelink SSB is based on the value of the power offset.

In some examples, the output of the ML model includes an indication to transmit the sidelink SSB as an independent synchronization reference. In some examples, transmission of the sidelink SSB is based on the indication.

In some examples, the control signaling manager 825 is capable of, configured to, or operable to support a means for receiving second control signaling that indicates a configuration for the ML model.

In some examples, the control signaling manager 825 is capable of, configured to, or operable to support a means for receiving second control signaling that indicates one or more parameters for training the ML model. In some examples, the ML model training component 860 is capable of, configured to, or operable to support a means for training the ML model in accordance with the one or more parameters and in accordance with measured values associated with the one or more parameters.

In some examples, the control signaling manager 825 is capable of, configured to, or operable to support a means for receiving second control signaling that indicates one or more environmental parameters associated with a measurement procedure at the UE, where an input for the ML model is based on the one or more environmental parameters.

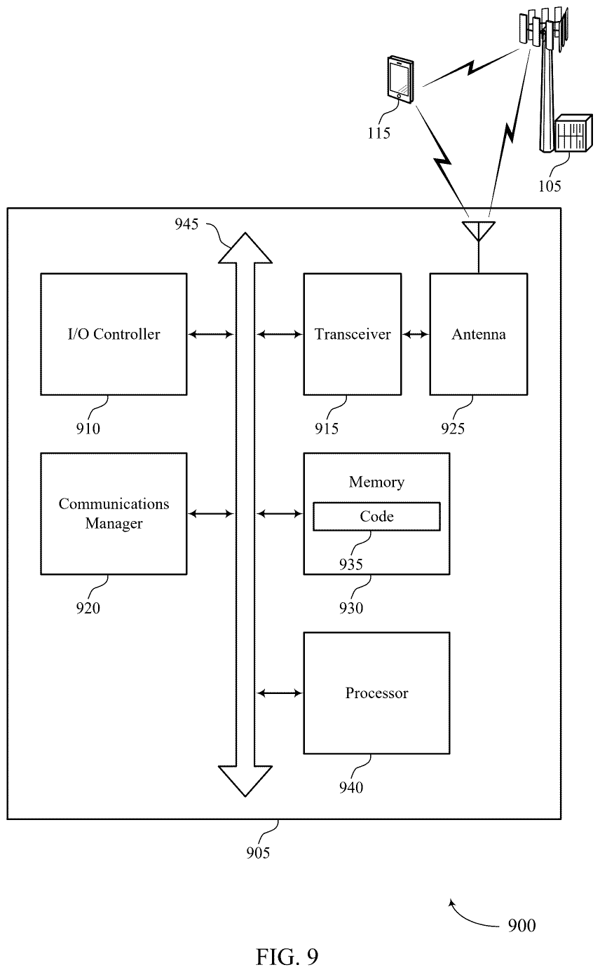

FIG. 9 shows a diagram of a system 900 including a device 905 that supports independent synchronization reference determination for sidelink synchronization in accordance with one or more aspects of the present disclosure. The device 905 may be an example of or include components of a device 605, a device 705, or a UE 115 as described herein. The device 905 may communicate (e.g., wirelessly) with one or more other devices (e.g., network entities 105, UEs 115, or a combination thereof). The device 905 may include components for bi-directional voice and data communications including components for transmitting and receiving communications, such as a communications manager 920, an input/output (I/O) controller, such as an I/O controller 910, a transceiver 915, one or more antennas 925, at least one memory 930, code 935, and at least one processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of one or more processors, such as the at least one processor 940. In some cases, a user may interact with the device 905 via the I/O controller 910 or via hardware components controlled by the I/O controller 910.

In some cases, the device 905 may include a single antenna. However, in some other cases, the device 905 may have more than one antenna, which may be capable of concurrently transmitting or receiving multiple wireless transmissions. The transceiver 915 may communicate bi-directionally via the one or more antennas 925 using wired or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The at least one memory 930 may include random access memory (RAM) and read-only memory (ROM). The at least one memory 930 may store computer-readable, computer-executable, or processor-executable code, such as the code 935. The code 935 may include instructions that, when executed by the at least one processor 940, cause the device 905 to perform various functions described herein. The code 935 may be stored in a non-transitory computer-readable medium such as system memory or another type of memory. In some cases, the code 935 may not be directly executable by the at least one processor 940 but may cause a computer (e.g., when compiled and executed) to perform functions described herein. In some cases, the at least one memory 930 may include, among other things, a basic I/O system (BIOS) which may control basic hardware or software operation such as the interaction with peripheral components or devices.

The at least one processor 940 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 940 may be configured to operate a memory array using a memory controller. In some other cases, a memory controller may be integrated into the at least one processor 940. The at least one processor 940 may be configured to execute computer-readable instructions stored in a memory (e.g., the at least one memory 930) to cause the device 905 to perform various functions (e.g., functions or tasks supporting independent synchronization reference determination for sidelink synchronization). For example, the device 905 or a component of the device 905 may include at least one processor 940 and at least one memory 930 coupled with or to the at least one processor 940, the at least one processor 940 and the at least one memory 930 configured to perform various functions described herein.

In some examples, the at least one processor 940 may include multiple processors and the at least one memory 930 may include multiple memories. One or more of the multiple processors may be coupled with one or more of the multiple memories, which may, individually or collectively, be configured to perform various functions described herein. In some examples, the at least one processor 940 may be a component of a processing system, which may refer to a system (such as a series) of machines, circuitry (including, for example, one or both of processor circuitry (which may include the at least one processor 940) and memory circuitry (which may include the at least one memory 930)), or components, that receives or obtains inputs and processes the inputs to produce, generate, or obtain a set of outputs. The processing system may be configured to perform one or more of the functions described herein. For example, the at least one processor 940 or a processing system including the at least one processor 940 may be configured to, configurable to, or operable to cause the device 905 to perform one or more of the functions described herein. Further, as described herein, being “configured to,” being “configurable to,” and being “operable to” may be used interchangeably and may be associated with a capability, when executing code 935 (e.g., processor-executable code) stored in the at least one memory 930 or otherwise, to perform one or more of the functions described herein.

The communications manager 920 may support wireless communications in accordance with examples as disclosed herein. For example, the communications manager 920 is capable of, configured to, or operable to support a means for receiving control signaling that indicates a range of a power offset associated with a synchronization signal. The communications manager 920 is capable of, configured to, or operable to support a means for monitoring a wireless channel for the synchronization signal. The communications manager 920 is capable of, configured to, or operable to support a means for transmitting a sidelink SSB as an independent synchronization reference based on the monitoring and the range of the power offset associated with the synchronization signal.

By including or configuring the communications manager 920 in accordance with examples as described herein, the device 905 may support techniques for improved communication reliability, reduced latency, more efficient utilization of communication resources, improved coordination between devices, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the at least one processor 940, the at least one memory 930, the code 935, or any combination thereof. For example, the code 935 may include instructions executable by the at least one processor 940 to cause the device 905 to perform various aspects of independent synchronization reference determination for sidelink synchronization as described herein, or the at least one processor 940 and the at least one memory 930 may be otherwise configured to, individually or collectively, perform or support such operations.

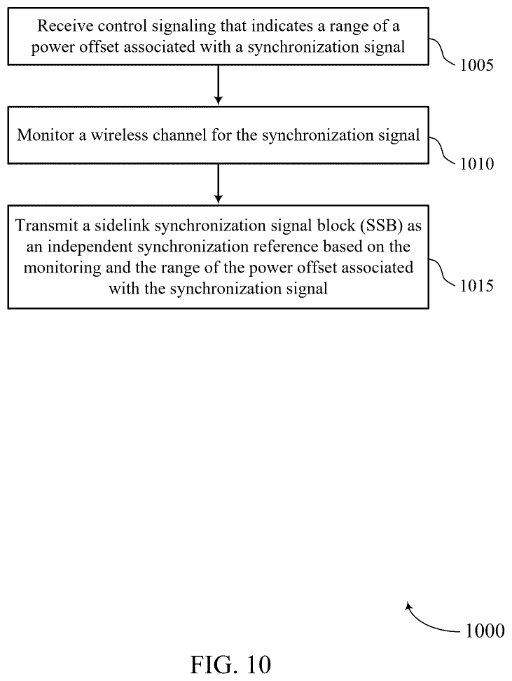

FIG. 10 shows a flowchart illustrating a method 1000 that supports independent synchronization reference determination for sidelink synchronization in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include receiving control signaling that indicates a range of a power offset associated with a synchronization signal. The operations of 1005 may be performed in accordance with examples as disclosed herein, such as the transmission of message 220 of FIG. 2 and the transmission of the control signaling at 505 of FIG. 5. In some examples, aspects of the operations of 1005 may be performed by a control signaling manager 825 as described with reference to FIG. 8 and/or by one or more transceivers 915, antennas 925, memories 930, or processors 940 as described with reference to FIG. 9.

At 1010, the method may include monitoring a wireless channel for the synchronization signal. The operations of 1010 may be performed in accordance with examples as disclosed herein, such as the monitoring for the synchronization signal at 515 of FIG. 5, and described further with reference to FIGS. 2-4. In some examples, aspects of the operations of 1010 may be performed by a wireless channel monitoring manager 830 as described with reference to FIG. 8 and/or by one or more transceivers 915, antennas 925, memories 930, or processors 940 as described with reference to FIG. 9.

At 1015, the method may include transmitting a sidelink SSB as an independent synchronization reference based on the monitoring and the range of the power offset associated with the synchronization signal. The operations of 1015 may be performed in accordance with examples as disclosed herein, such as the sidelink SSB transmissions 205 of FIG. 2, the sidelink SSB transmission at 540 of FIG. 5, and further described with reference to FIGS. 3 and 4. In some examples, aspects of the operations of 1015 may be performed by an SL SSB manager 835 as described with reference to FIG. 8 and/or by one or more transceivers 915, antennas 925, memories 930, or processors 940 as described with reference to FIG. 9.

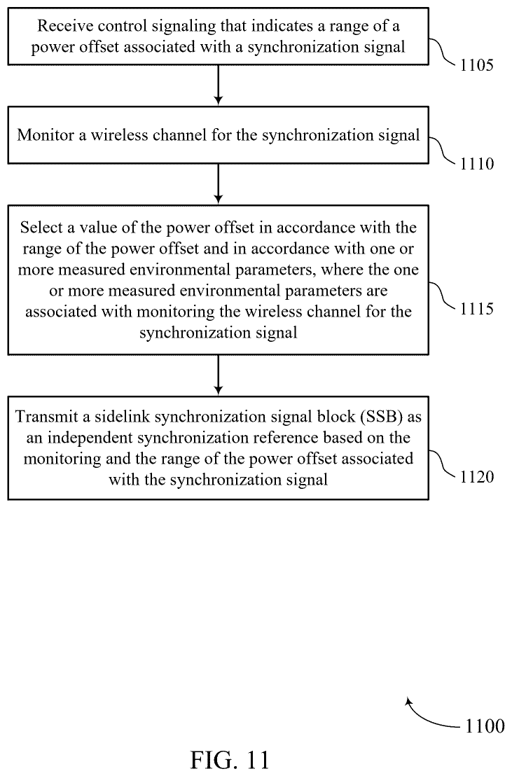

FIG. 11 shows a flowchart illustrating a method 1100 that supports independent synchronization reference determination for sidelink synchronization in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include receiving control signaling that indicates a range of a power offset associated with a synchronization signal. The operations of 1105 may be performed in accordance with examples as disclosed herein, such as the transmission of message 220 in FIG. 2 and the transmission of the control signaling at 505 in FIG. 5. In some examples, aspects of the operations of 1105 may be performed by a control signaling manager 825 as described with reference to FIG. 8 and/or by one or more transceivers 915, antennas 925, memories 930, or processors 940 as described with reference to FIG. 9.

At 1110, the method may include monitoring a wireless channel for the synchronization signal. The operations of 1110 may be performed in accordance with examples as disclosed herein, such as the monitoring for the synchronization signal at 515 in FIG. 5, and described further with reference to FIGS. 2-4. In some examples, aspects of the operations of 1110 may be performed by a wireless channel monitoring manager 830 as described with reference to FIG. 8 and/or by one or more transceivers 915, antennas 925, memories 930, or processors 940 as described with reference to FIG. 9.

At 1115, the method may include selecting a value of the power offset in accordance with the range of the power offset and in accordance with one or more measured environmental parameters, where the one or more measured environmental parameters are associated with monitoring the wireless channel for the synchronization signal. The operations of 1115 may be performed in accordance with examples as disclosed herein, such as the selection of the power offset value at 525 of FIG. 5 and described further with regard to FIG. 4. In some examples, aspects of the operations of 1115 may be performed by a power offset value selector 840 as described with reference to FIG. 8 and/or by one or more memories 930 or processors 940 as described with reference to FIG. 9.

At 1120, the method may include transmitting a sidelink SSB as an independent synchronization reference based on the monitoring and the range of the power offset associated with the synchronization signal. The operations of 1120 may be performed in accordance with examples as disclosed herein, such as the sidelink SSB transmissions 205 of FIG. 2, the sidelink SSB transmission at 540 of FIG. 5, and further described with reference to FIGS. 3 and 4. In some examples, aspects of the operations of 1120 may be performed by an SL SSB manager 835 as described with reference to FIG. 8 and/or by one or more transceivers 915, antennas 925, memories 930, or processors 940 as described with reference to FIG. 9.

The following provides an overview of aspects of the present disclosure:

Aspect 1: A method for wireless communications at a UE, comprising: receiving control signaling that indicates a range of a power offset associated with a synchronization signal; monitoring a wireless channel for the synchronization signal; and transmitting a sidelink SSB as an independent synchronization reference based at least in part on the monitoring and the range of the power offset associated with the synchronization signal.

Aspect 2: The method of aspect 1, further comprising: selecting a value of the power offset in accordance with the range of the power offset and in accordance with one or more measured environmental parameters, wherein the one or more measured environmental parameters are associated with monitoring the wireless channel for the synchronization signal.

Aspect 3: The method of aspect 2, wherein the one or more measured environmental parameters include one or more of a received signal strength, a SINR, a SLSSID, a power delay profile, a channel impulse response, a difference in time between a plurality of synchronization signals, a difference in frequency between the plurality of synchronization signals, or any combination thereof, the plurality of synchronization signals comprises the synchronization signal.

Aspect 4: The method of any of aspects 2 through 3, further comprising: transmitting an indication of the one or more measured environmental parameters.

Aspect 5: The method of any of aspects 2 through 4, wherein the one or more measured environmental parameters and the range of the power offset comprise input parameters for a ML model.

Aspect 6: The method of any of aspects 1 through 5, further comprising: receiving the synchronization signal based at least in part on monitoring the wireless channel; and comparing a power associated with the synchronization signal to a threshold power, the threshold power associated with the power offset associated with the range of the power offset, wherein transmission of the sidelink SSB is based at least in part on the comparing.

Aspect 7: The method of any of aspects 1 through 6, wherein transmitting the sidelink SSB further comprises: transmitting the sidelink SSB based at least in part on an internal timing associated with an internal clock at the UE.

Aspect 8: The method of any of aspects 1 through 7, wherein the range of the power offset comprises a maximum value and a minimum value, one or more candidate values for the power offset, or any combination thereof.

Aspect 9: The method of any of aspects 1 through 8, wherein transmitting the sidelink SSB further comprises: transmitting the sidelink SSB based at least in part on an output of a ML model.

Aspect 10: The method of aspect 9, wherein the output of the ML model comprises a value of the power offset in accordance with the range of the power offset, transmission of the sidelink SSB is based at least in part on the value of the power offset.

Aspect 11: The method of any of aspects 9, wherein the output of the ML model comprises an indication to transmit the sidelink SSB as an independent synchronization reference, transmission of the sidelink SSB is based at least in part on the indication.

Aspect 12: The method of any of aspects 9 through 11, further comprising: receiving second control signaling that indicates a configuration for the ML model.

Aspect 13: The method of any of aspects 9 through 12, further comprising: receiving second control signaling that indicates one or more parameters for training the ML model; and training the ML model in accordance with the one or more parameters and in accordance with measured values associated with the one or more parameters.

Aspect 14: The method of any of aspects 9 through 13, further comprising: receiving second control signaling that indicates one or more environmental parameters associated with a measurement procedure at the UE, wherein an input for the ML model is based at least in part on the one or more environmental parameters.

Aspect 15: A UE for wireless communications, comprising one or more memories storing processor-executable code, and one or more processors coupled with the one or more memories and individually or collectively operable to execute the code to cause the UE to perform a method of any of aspects 1 through 14.

Aspect 16: A UE for wireless communications, comprising at least one means for performing a method of any of aspects 1 through 14.

Aspect 17: A non-transitory computer-readable medium storing code for wireless communications, the code comprising instructions executable by one or more processors to perform a method of any of aspects 1 through 14.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive control signaling that indicates a range of a power offset associated with a synchronization signal;
monitor a wireless channel for the synchronization signal; and
transmit a sidelink synchronization signal block as an independent synchronization reference based at least in part on the monitoring and the range of the power offset associated with the synchronization signal.

2. The UE of claim 1, wherein the one or more processors are individually or collectively further operable to execute the code to cause the UE to:
select a value of the power offset in accordance with the range of the power offset and in accordance with one or more measured environmental parameters, wherein the one or more measured environmental parameters are associated with monitoring the wireless channel for the synchronization signal.

3. The UE of claim 2, wherein the one or more measured environmental parameters include one or more of a received signal strength, a signal to interference noise ratio, a sidelink service set identifier, a power delay profile, a channel impulse response, a difference in time between a plurality of synchronization signals, a difference in frequency between the plurality of synchronization signals, or any combination thereof, wherein the plurality of synchronization signals comprises the synchronization signal.

4. The UE of claim 2, wherein the one or more processors are individually or collectively further operable to execute the code to cause the UE to:
transmit an indication of the one or more measured environmental parameters.

5. The UE of claim 2, wherein the one or more measured environmental parameters and the range of the power offset comprise input parameters for a machine learning model.

6. The UE of claim 1, wherein the one or more processors are individually or collectively further operable to execute the code to cause the UE to:
receive the synchronization signal based at least in part on monitoring the wireless channel; and
compare a power associated with the synchronization signal to a threshold power, the threshold power associated with the power offset associated with the range of the power offset, wherein transmission of the sidelink synchronization signal block is based at least in part on the comparing.

7. The UE of claim 1, wherein, to transmit the sidelink synchronization signal block, the one or more processors are individually or collectively further operable to execute the code to cause the UE to:
transmit the sidelink synchronization signal block based at least in part on an internal timing associated with an internal clock at the UE.

8. The UE of claim 1, wherein the range of the power offset comprises a maximum value and a minimum value, one or more candidate values for the power offset, or any combination thereof.

9. The UE of claim 1, wherein, to transmit the sidelink synchronization signal block, the one or more processors are individually or collectively further operable to execute the code to cause the UE to:
transmit the sidelink synchronization signal block based at least in part on an output of a machine learning model.

10. The UE of claim 9, wherein the output of the machine learning model comprises a value of the power offset in accordance with the range of the power offset, wherein transmission of the sidelink synchronization signal block is based at least in part on the value of the power offset.

11. The UE of claim 9, wherein the output of the machine learning model comprises an indication to transmit the sidelink synchronization signal block as an independent synchronization reference, wherein transmission of the sidelink synchronization signal block is based at least in part on the indication.

12. The UE of claim 9, wherein the one or more processors are individually or collectively further operable to execute the code to cause the UE to:
receive second control signaling that indicates a configuration for the machine learning model.

13. The UE of claim 9, wherein the one or more processors are individually or collectively further operable to execute the code to cause the UE to:
receive second control signaling that indicates one or more parameters for training the machine learning model; and
train the machine learning model in accordance with the one or more parameters and in accordance with measured values associated with the one or more parameters.

14. The UE of claim 9, wherein the one or more processors are individually or collectively further operable to execute the code to cause the UE to:
receive second control signaling that indicates one or more environmental parameters associated with a measurement procedure at the UE, wherein an input for the machine learning model is based at least in part on the one or more environmental parameters.

15. A method for wireless communications at a user equipment (UE), comprising:
receiving control signaling that indicates a range of a power offset associated with a synchronization signal;
monitoring a wireless channel for the synchronization signal; and
transmitting a sidelink synchronization signal block as an independent synchronization reference based at least in part on the monitoring and the range of the power offset associated with the synchronization signal.

16. The method of claim 15, further comprising:
selecting a value of the power offset in accordance with the range of the power offset and in accordance with one or more measured environmental parameters, wherein the one or more measured environmental parameters are associated with monitoring the wireless channel for the synchronization signal.

17. The method of claim 16, further comprising:
transmitting an indication of the one or more measured environmental parameters.

18. The method of claim 15, further comprising:
receiving the synchronization signal based at least in part on monitoring the wireless channel; and
comparing a power associated with the synchronization signal to a threshold power, the threshold power associated with the power offset associated with the range of the power offset, wherein transmission of the sidelink synchronization signal block is based at least in part on the comparing.

19. The method of claim 15, wherein transmitting the sidelink synchronization signal block further comprises:
transmit the sidelink synchronization signal block based at least in part on an internal timing associated with an internal clock at the UE.

20. The method of claim 15, wherein transmitting the sidelink synchronization signal block further comprises:
transmitting the sidelink synchronization signal block based at least in part on an output of a machine learning model.
